(19) United States
(12) Patent Application Publication
(10) Pub. No.: US 2008/0287324 A1
(43) Pub. Date: Nov. 20, 2008

(54) Process for well cleaning

(75) Inventors: John Thomas Pursley, Castle Rock, CO (US); David L. Holcomb, Golden, CO (US); Glenn S. Penny, The Woodlands, TX (US)

Correspondence Address: CROWE AND DUNLEVY, P.C., 20 NORTH BROADWAY, SUITE 1800, OKLAHOMA CITY, OK, 73102-8273, US

(73) Assignee: CESI Chemical, Inc., A Flotek Company, The Woodlands, TX (US)

(21) Appl. No.: 12/156,201

(22) Filed: May 30, 2008

Related U.S. Application Data
(63) Continuation-in-part of application No. 10/377,322, filed on Feb. 28, 2003, now Pat. No. 7,380,606.
(60) Provisional application No. 60/361,438, filed on Mar. 1, 2002.

(51) Int. Cl. C09K 8/52

(52) U.S. Cl. 507/218

(57) ABSTRACT

Disclosed is a method for treating an oil or gas well having a wellbore that includes the steps of forming a solvent-surfactant blend by combining a solvent and a surfactant, adding a diluent to the solvent-surfactant blend to form an emulsified solvent-surfactant blend; combining the emulsified solvent-surfactant blend with a water-based carrier fluid to form a well treatment microemulsion, and injecting the well treatment microemulsion into the oil or gas well. In a preferred embodiment, the step of forming a solvent-surfactant blend includes combining a surfactant with a solvent selected from the group consisting of terpenes and alkyl or aryl esters of short chain alcohols.

### RELATED APPLICATIONS

This application is a continuation-in-part of prior U.S. patent application Ser. No. 10/377,322, filed Feb. 28, 2003, titled Composition and Process for Well Cleaning, which claims the benefit of U.S. Provisional Patent Application No. 60/361,438 filed Mar. 1, 2002, titled Composition and Process for Well Cleaning. Application Ser. Nos. 10/377,322 and 60/361,438 are hereby incorporated by reference.

### FIELD OF THE INVENTION

The present invention generally relates to the production of petroleum products and more particularly to a process for improving the recovery of petroleum products from a subterranean geological formation.

### BACKGROUND OF THE INVENTION

For many years, petroleum products have been recovered from subterranean reservoirs through the use of drilled wells and production equipment. During the production of desirable hydrocarbons, such as crude oil and natural gas, a number of other naturally occurring substances may also be encountered within the subterranean environment.

For example, hydrogen sulfide (H₂S) is a highly toxic, colorless gas that is produced during the decomposition of organic matter. In some areas, hydrogen sulfide gas is produced in large quantities during the retrieval of petroleum products. At relatively low concentrations (200 ppm) and minimal exposure times, hydrogen sulfide gas can be lethal. In areas prone to the production of hydrogen sulfide, drilling crews must be prepared to use detection and protective equipment at all times. The contamination of well sites from hydrogen sulfide gas is a significant environmental concern that requires extensive remediation. Additionally, during downstream processing, hydrogen sulfide is typically removed from refined products through expensive and waste-extensive procedures. The control and mitigation of hydrogen sulfide is a significant business that is strictly regulated throughout petroleum producing countries.

Other undesirable downhole products must be managed during the production of hydrocarbons in addition to hydrogen sulfide. For example, scale, paraffins, fines, sulfur, heavy oil tar by-products and water blocks commonly accumulate in and around the formation, well casing, production tubing and recovery equipment. Alternatively, it may be necessary to remove injected fluids from the near wellbore area, such as drilling fluids, cement filtrate, kill fluids, polymers and water blocks. To maintain an efficient recovery of petroleum products, it is frequently necessary to clean or remove these accumulations and deposits.

The removal of unwanted deposits from the wellbore and production equipment is generally referred to as “remediation.” In contrast, the term “stimulation” generally refers to the treatment of geological formations to improve the recovery of hydrocarbons. Common stimulation techniques include well fracturing and acidizing operations. Well remediation and stimulation are important services that are offered through a variety of techniques by a large number of companies.

Although a number of compounds and techniques are known in the prior art, there is a continued need for more effective methods and compounds for hydrogen sulfide mitigation, wellbore remediation, drilling operations and formation stimulation.

### SUMMARY OF THE INVENTION

The present invention includes a method for treating an oil or gas well in which a solvent-surfactant blend is formed by combining a solvent and a surfactant, and a diluent is added to the solvent-surfactant blend to form an emulsified solvent-surfactant blend. The emulsified solvent-surfactant blend is combined with a water-based or oil-based carrier fluid to form a well-treatment microemulsion, and the well treatment microemulsion is injected into the oil or gas well. In a preferred embodiment, the step of forming a solvent-surfactant blend includes a combining a surfactant with a solvent selected from the group consisting of terpenes and alkyl or aryl esters of short chain alcohols.

### DETAILED DESCRIPTION OF THE PREFERRED EMBODIMENT

The present invention relates to the preparation and use of a well treatment microemulsion in the management of undesirable downhole products encountered during the production of hydrocarbons from subterranean reservoirs. Unlike prior art cleaning and stimulation fluids, the well treatment microemulsions of the present invention are stablilized microemulsions that are formed by the combination of solvent-surfactant blends with an appropriate oil-based or water-based carrier fluid.

The solvent-surfactant blend generally includes a solvent, a surfactant and an alcohol. In a presently preferred embodiment, the solvent is selected from the group of unsaturated aliphatic cyclic hydrocarbons known as terpenes, including monoterpenes and diterpenes. In a particularly preferred embodiment, the solvent is the monoterpene d-limonene (C₁₀H₁₆). Terpenes, such as d-limonene, are preferred for their solvent qualities and biodegradability.

In an alternate embodiment, the terpene-based solvent is replaced with alkyl, cyclic or aryl acid esters of short chain alcohols, such as ethyl lactate and hexyl ester. Ethyl lactate is a low cost, environmentally safe solvent that can be manufactured from carbohydrates, such as cornstarch. Although acceptable for well remediation and stimulation, ethyl lactate is not generally recommended for use in hydrogen sulfide mitigation applications. It will also be understood that combinations of different solvents, such as d-limonene and ethyl lactate, are also encompassed within the scope of the present invention.

The selection of the surfactant component for the solvent-surfactant blend is determined by the type of carrier fluid selected. Water-based carrier fluids, such as fresh water and brine, are typically more environmentally friendly and cost effective. Oil-based carrier fluids, such as diesel, kerosene, jet fuel, crude oil, and condensate may provide enhanced performance but are generally more expensive and environmentally restricted. More environmentally friendly synthetics such as esters, linear-α-olefins, poly-α-olefins, internal olefins, paraffins, linear alkyl benzenes, esthers, acetals, and other synthetics may also be used as oil-based carrier fluids.

If a water-based carrier fluid is chosen, the surfactant of the solvent-surfactant blend should be capable of creating an oil-in-water microemulsion upon combination with an appropriate quantity of water. Preferred surfactants are biodegradable and have an HLB (hydrophile-lipophile balance) value of between about 8-20. Preferred surfactants may be cationic, anionic, zwitterionic, or nonionic. Presently preferred oil-in-water surfactants include one or more of the following: Tween® 40 (polyoxyethylene sorbitan monopalmitate), Tween®60 (polyoxyethylene sorbitan monostearate), Tween® 80 (polyoxyethylene sorbitan monooleate), linear alcohol alkoxylates, alkyl ether sulfates, dodecylbenzene sulfonic acid (DDBSA), linear nonyl-phenols, dioxane, ethylene oxide, polyethylene glycol, and ethoxylated castor oils such as PEG castor oil. A preferred oil-in-water surfactant mixture includes polyoxyethylene sorbitan monopalmitate, ethoxylated castor oil and polyethylene glycol.

Alternately preferred oil-in-water surfactants can also include dipalmitoyl-phosphatidylcholine (DPPC), sodium 4-(1′ heptylnonyl) benzenesulfonate (SHPS or SHBS), polyoxyethylene (8.6 mole) nonyl phenyl ether, AEROSOL® OT (sodium dioctyl sulphosuccinate), tetraethyleneglycoldodecylether, sodium octlylbenzenesulfonate (OBS), sodium hexadecyl sulfate (SCS), IsalChem® 145 (PO) (isomeric primary alcohol (oxypropylene surfactant)), sodium alkyl ether sulfate, sodium laureth sulfate POE(2) (SLES), ethylene oxide (EO), sulfonates (i.e., alkyl propoxy-ethoxysulfonate), alkyl propoxy-ethoxysulfate, alkylaryl-propoxy-ethoxysulfonate and highly substituted benzene sulfonates (n-C12-oxylene-SO3-).

If an oil-based carrier fluid is chosen, the surfactant of the solvent-surfactant blend should be capable of creating a water-in-oil microemulsion upon combination with oil. Preferred surfactants may be cationic, anionic, zwitterionic, or nonionic. Preferred surfactants are biodegradable and have an HLB value of between about 3-8. Presently preferred water-in-oil surfactants include Span® 40 (sorbitan monopalmitate), Span® 60 (sorbitan monostearate), Span® 80 (sorbitan monooleate), linear alcohol alkoxylates, ethoxylated castor oil, and polyethylene glycol. A preferred water-in-oil surfactant mixture includes sorbitan monopalmitate, ethoxylated castor oil and polyethylene glycol.

The alcohol component of the solvent-surfactant blend serves as a coupling agent between the solvent and the surfactant, thereby stabilizing the microemulsion. The alcohol also lowers the freezing point of the well treatment microemulsion. Although isopropanol is presently preferred, alternative suitable alcohols include midrange primary, secondary and tertiary alcohols with between 1 and 20 carbon atoms, such as t-butanol, n-butanol, n-pentanol, n-hexanol and 2-ethyl-hexanol. Other freeze prevention additives can additionally or alternatively be added, such as detergent range alcohol ethoxylates, ethylene glycols (EG), polyethylene glycols (PEG), propylene glycols (PG) and triethylene glycols (TEG), with triethylene glycol being presently preferred.

The solvent-surfactant blend optionally includes a salt. The addition of a salt to the solvent-surfactant blend reduces the amount of water needed as a carrier fluid and also lowers the freezing point of the well treatment microemulsion. Among the salts that may be added for stability and co-solvent substitution, NaCl, KCl, CaCl₂, and MgCl₂ are presently preferred. Others suitable salts can be formed from K, Na, Zn, Br, Sr, Cs, Li, and Ca families.

After blending the solvents, surfactants and alcohols, it may be desirable to form a diluted solvent-surfactant blend by adding a diluent before addition to the carrier fluid. Presently preferred diluents include water and water and triethylene glycol (TEG) mixtures. A particularly preferred diluent is 90% by volume water and 10% by volume triethylene glycol. It will be understood that upon addition of the diluent, the solvent-surfactant blend may partially or completely emulsify. It will also be understood that complete emulsification includes, without limitation, microemulsification.

For oil-in-water well treatment microemulsions, the solvent-surfactant blend preferably includes about 36%-76% by volume of the surfactant, about 14%-54% by volume solvent, and about 0%-20% alcohol by volume. In a particularly preferred embodiment, the oil-in-water solvent-surfactant blend includes about 56% by volume of the preferred oil-in-water surfactant mixture (polyoxyethylene sorbitan monopalmitate, ethoxylated castor oil and polyethylene glycol), about 34% by volume d-limonene, ethyl lactate or combinations thereof, and about 10% by volume isopropanol.

In an alternatively preferred embodiment, the oil-in-water solvent-surfactant blend is diluted with about 0%-50% by volume of diluent. The diluted solvent-surfactant blend preferably includes water and more preferably includes about 45% by volume water and about 5% by volume triethylene glycol. Accordingly, the preferred diluted solvent-surfactant blend includes about 27% by volume of the preferred oil-in-water surfactant mixture, about 17% by volume d-limonene, about 5% by volume isopropanol, about 45% by volume water and about 5% by volume triethylene glycol.

For water-in-oil well treatment microemulsions, the solvent-surfactant blend preferably includes about 36%-76% by volume of the surfactant, about 14%-54% by volume solvent and about 0%-20% by volume alcohol. In a particularly preferred embodiment, the water-in-oil solvent-surfactant blend includes about 56% by volume of the preferred water-in-oil surfactant mixture (sorbitan monopalmitate, ethoxylated castor oil and polyethylene glycol), about 34% by volume d-limonene, ethyl lactate or a combination of d-limonene and ethyl lactate, and about 10% by volume isopropanol. The water-in-oil solvent-surfactant blend forms a microemulsion upon combination with diesel or kerosene to form a preferred water-in-oil well treatment microemulsion.

In an alternatively preferred embodiment, the water-in-oil solvent-surfactant blend is combined with about 0%-50% by volume of a diluent prior to adding the carrier fluid to form a diluted water-in-oil solvent-surfactant blend. More preferably, about 50% by volume of diluent is added to the water-in-oil solvent-surfactant blend. The diluent is preferably an oil-based fluid such as diesel, kerosene, jet fuel, crude oil, condensate, an ester, linear-α-olefin, poly-α-olefin, internal olefin, paraffin, linear alkyl benzene, esther, acetal, or other synthetic. In a preferred embodiment, diesel or condensate is used as a diluent. It will be understood that upon addition of the diluent, the water-in-oil solvent-surfactant blend may partially or completely emulsify. It will also be understood that complete emulsification includes, without limitation, microemulsification.

The solvent-surfactant blends, dilute or concentrated, can be added to the water and oil-based carrier fluids in sparing amounts to prepare the desired well treatment microemulsions. For example, in many applications, as little as 0.2%-2% by volume of solvent-surfactant blend in water or oil based-carrier fluids will be sufficient. In other applications, however, it may be desirable to use a more concentrated well treatment microemulsion. In such applications, the well treatment microemulsion preferably includes about 0.5% to about 90% of the selected solvent-surfactant blend. In another preferred application, the well treatment microemulsion includes about 0.05% to about 50% by volume of the solvent-surfactant blend. Furthermore, it will be understood that in some applications, it may be desirable to apply the solvent-surfactant blend, diluted or concentrated, without the addition of a carrier fluid. For example, the solvent-surfactant blend can be pumped downhole where it will incorporate water and water-based materials to form the well treatment microemulsion in situ. Once formed, the well treatment microemulsion can be pumped from the wellbore to the surface. In another embodiment, the solvent-surfactant blend can be injected downhole via a capillary injection assembly and to mix in situ with water or oil-based fluid, to form a well treatment microemulsion.

Although for the purposes of the present disclosure preferred embodiments of the well treatment microemulsions are described in connection with well remediation, stimulation, acidizing operations, drilling operations and hydrogen sulfide mitigation applications, it will be understood that the inventive well treatment microemulsions can be used in additional, alternative applications. For example, it is contemplated that the well treatment microemulsion could also be used to clean surface equipment and downhole equipment.

In well remediation applications, the selected well treatment microemulsion is preferably injected directly into the wellbore through the production tubing or through the use of coiled tubing or similar delivery mechanisms. Once downhole, the well treatment microemulsion remedies drilling damage, fracturing fluid damage, water blocks and removes fines, asphaltenes and paraffins from the formation and wellbore. The well treatment microemulsion also serves to thin heavy hydrocarbons, alleviate water blocks and lower pore pressure in the formation. If paraffin accumulation is significant, ethyl lactate or ethyl lactate and d-limonene mixtures are preferred as solvents.

During drilling operations, the well treatment microemulsions can be added to drilling fluids and injected into the wellbore through the drill string. The well treatment microemulsion is effective at removing fines and debris from the wellbore created by the drilling process. The surfactant used in the solvent-surfactant blend should be selected according to whether oil or water based drilling fluids are used.

The inventive well treatment microemulsions can also be used in stimulation operations. In fracturing operations, proppant material can be added to the microemulsion before injection downhole. The microemulsion is particularly effective at decreasing the density of filter cakes during high pressure injection of gelled fluids into the wellbore.

The well treatment microemulsions can also be used to deliver acids during acidizing operations. Acids commonly used include hydrochloric, acetic, formic, hydrofluoric, fluoboric, and hydrochloric-hydrofluoric acids. In a presently preferred embodiment, the selected solvent-surfactant blend (dilute or concentrate) is combined with an acidified carrier fluid to prepare a microemulsion suitable for acidizing operations. Preferably, the microemulsion includes about 0.2%-5% by volume of the solvent-surfactant blend and about 3%-28% by volume of acid. In a particularly preferred embodiment, the microemulsion includes about 0.2%-5% of the solvent-surfactant blend and about 15% by volume of hydrochloric acid. The concentration of the well treatment microemulsion in gelled fluids lowers the friction created by contact with conduits, thereby facilitating the injection and withdrawal of the well treatment microemulsion.

As mentioned above, the inventive microemulsions can also be used for hydrogen sulfide mitigation. In preferred embodiments, the well treatment microemulsions are injected into the wellbore so that escaping hydrogen sulfide gas is “stripped” through the well treatment microemulsions. Preferably, the inventive microemulsion is periodically injected into problem wells to mitigate hydrogen sulfide production. Alternatively, the microemulsion can be injected downhole via capillary tubing on a continuous basis. In yet another alternate embodiment, the well treatment microemulsion can be placed in a container that is placed in fluid communication with the hydrogen sulfide.

In a preferred embodiment, some or all of the water or oil-based carrier fluid is replaced with a known hydrogen sulfide scavenger. For example, many cyclic amines, such as triazines and hexamines, can be used as a solvent alone or in combination with water or oil-based carrier fluids to further improve hydrogen sulfide mitigation.

The interaction between the well treatment microemulsions and the hydrogen sulfide neutralizes the hydrogen sulfide, leaving an inert sulfur compound as a product of the reaction. Significantly, benzothiophenes are also produced as a by-product of the reaction between the hydrogen sulfide and the well treatment microemulsions. Pharmaceutical researchers have recently discovered that benzothiophenes can be used as an intermediate in the synthesis of a number of useful chemical compounds.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed and as defined in the written description and appended claims.

It is claimed:

1. A method for treating an oil or gas well having a wellbore, comprising:
forming a solvent-surfactant blend by combining a solvent and a surfactant;
adding a diluent to the solvent-surfactant blend to form an emulsified solvent-surfactant blend;
combining the emulsified solvent-surfactant blend with a water-based carrier fluid to form a well treatment microemulsion; and
injecting the well treatment microemulsion into the oil or gas well.

2. The method of claim 1, wherein the step of forming a solvent-surfactant blend comprises combining a solvent with a surfactant that has a hydrophile-lipophile balance of between about 8 to 20.

3. The method of claim 1, wherein the step of forming a solvent-surfactant blend comprises combining a solvent with a cationic surfactant.

4. The method of claim 1, wherein the step of forming a solvent-surfactant blend comprises combining a solvent with an anionic surfactant.

5. The method of claim 1, wherein the step of forming a solvent-surfactant blend comprises combining a solvent with a zwitterionic surfactant.

6. The method of claim 1, wherein the step of forming a solvent-surfactant blend comprises combining a solvent with a nonionic surfactant.

7. The method of claim 1, wherein the step of forming a solvent-surfactant blend comprises combining a solvent with a surfactant that is selected from the group consisting of ethoxylated castor oil, polyoxyethylene sorbitan monopalmitate, and polyethylene glycol.

8. The method of claim 1, wherein the step of forming a solvent-surfactant blend comprises combining a solvent with a surfactant that is selected from the group consisting of linear alcohol alkoxylates, alkyl ether sulfates, dodecylbenzene sulfonic acid, and linear nonyl-phenols.

9. The method of claim 1, wherein the carrier fluid comprises one or more acids selected from the group of hydrochloric, acetic, formic, hydrochloric-hydrofluoric, hydrofluoric, and fluoboric acids.

10. The method of claim 1, wherein the step of forming a solvent-surfactant blend comprises combining a solvent, a surfactant and an alcohol, wherein the alcohol comprises 1 to 20 carbon atoms.

11. The method of claim 1, wherein the step of forming a solvent-surfactant blend comprises combining a solvent, a surfactant and an alcohol that is selected from the group consisting of t-butanol, n-butanol, n-hexanol, 2-ethyl-hexanol, n-pentanol, and isopropyl alcohol.

12. The method of claim 1, wherein the step of forming a solvent-surfactant blend comprises combining a solvent, a surfactant and a freeze prevention additive that is selected from the group consisting of detergent range alcohol ethoxylates, ethylene glycols, polyethylene glycols, propylene glycols, and triethylene glycols.

13. The method of claim 1, wherein the step of forming a solvent-surfactant blend comprises combining a solvent selected from the group consisting of terpenes, alkyl esters of short chain alcohols and aryl esters of short chain alcohols with a surfactant to form a solvent-surfactant blend.

14. The method of claim 1, wherein the step of adding a diluent to the solvent-surfactant blend comprises adding a diluent that is selected from the group consisting of water and a water-triethylene glycol mixture to the solvent-surfactant blend to form an emulsified solvent-surfactant blend.

15. The method of claim 1, wherein the step of forming a solvent-surfactant blend comprises combining a solvent, a surfactant, an alcohol and a salt that is selected from the group consisting of potassium salts, sodium salts, zinc salts, bromine salts, strontium salts, cesium salts, lithium salts, and calcium salts to form a solvent-surfactant blend.

16. The method of claim 1, wherein the step of forming a solvent-surfactant blend comprises combining a solvent, a surfactant, an alcohol and a salt that is selected from the group consisting of NaCl, KCl, CaCl₂ and MgCl₂ to form a solvent-surfactant blend.

17. The method of claim 1, wherein the steps of forming a solvent-surfactant blend and adding a diluent are carried out such that the emulsified solvent-surfactant blend comprises:
18% to 76% by volume surfactant;
7% to 54% by volume solvent;
up to 20% by volume alcohol; and
up to 50% by volume diluent.

18. The method of claim 17, wherein the step of combining the emulsified solvent-surfactant blend with a water-based carrier fluid is carried out such that the well treatment microemulsion comprises:
from about 0.05% to about 50% by volume of emulsified solvent-surfactant blend; and
from about 50% to about 99.95% by volume of water-based carrier fluid.

19. The method of claim 17, wherein the step of combining the emulsified solvent-surfactant blend with a water-based carrier fluid is carried out such that the well treatment microemulsion comprises:
from about 0.2% to about 2% by volume of emulsified solvent-surfactant blend; and
from about 98% to about 99.8% by volume of water-based carrier fluid.

20. A method for treating an oil or gas well having a wellbore, comprising:
forming a solvent-surfactant blend by combining a solvent and a surfactant;
adding a diluent to the solvent-surfactant blend to form an emulsified solvent-surfactant blend;
combining the emulsified solvent-surfactant blend with an oil-based carrier fluid to form a well treatment microemulsion; and
injecting the well treatment microemulsion into the oil or gas well.

21. The method of claim 20, wherein the step of forming a solvent-surfactant blend comprises combining a solvent with a surfactant that has a hydrophile-lipophile balance of between about 3 to 8.

22. The method of claim 20, wherein the step of forming a solvent-surfactant blend comprises combining a solvent with a cationic surfactant.

23. The method of claim 20, wherein the step of forming a solvent-surfactant blend comprises combining a solvent with an anionic surfactant.

24. The method of claim 20, wherein the step of forming a solvent-surfactant blend comprises combining a solvent with a zwitterionic surfactant.

25. The method of claim 20, wherein the step of forming a solvent-surfactant blend comprises combining a solvent with a nonionic surfactant.

26. The method of claim 20, wherein the step of forming a solvent-surfactant blend comprises combining a solvent with a surfactant that is selected from the group consisting of ethoxylated castor oil, sorbitan monopalmitate, and polyethylene glycol.

27. The method of claim 20, wherein the step of forming a solvent-surfactant blend comprises combining a solvent with a surfactant that is selected from the group consisting of sorbitan monopalmitate, sorbitan monostearate, sorbinate monooleate, and linear alcohol alkoxylates.

28. The method of claim 20, wherein the step of forming a solvent-surfactant blend comprises combining a solvent, a surfactant and an alcohol, wherein the alcohol comprises 1 to 20 carbon atoms.

29. The method of claim 20, wherein the step of forming a solvent-surfactant blend comprises combining a solvent, a surfactant and an alcohol that is selected from the group consisting of t-butanol, n-butanol, n-hexanol and 2-ethyl-hexanol, n-pentanol, and isopropyl alcohol.

30. The method of claim 20, wherein the step of forming a solvent-surfactant blend comprises combining a solvent, a surfactant and a freeze prevention additive that is selected from the group consisting of detergent range alcohol ethoxylates, ethylene glycols, polyethylene glycols, propylene glycols, and triethylene glycols.

31. The method of claim 20, wherein the step of forming a solvent-surfactant blend comprises combining a solvent selected from the group consisting of terpenes, alkyl esters of short chain alcohols and aryl esters of short chain alcohols with a surfactant to form a solvent-surfactant blend.

32. The method of claim 20, wherein the step of adding a diluent to the solvent-surfactant blend comprises adding a diluent that is selected from the group consisting of diesel and condensate to the solvent-surfactant blend to form an emulsified solvent-surfactant blend.

33. The method of claim 20, wherein the step of forming a solvent-surfactant blend comprises combining a solvent, a surfactant, an alcohol and a salt that is selected from the group consisting of potassium salts, sodium salts, zinc salts, bromine salts, strontium salts, cesium salts, lithium salts, and calcium salts to form a solvent-surfactant blend.

34. The method of claim 20, wherein the step of forming a solvent-surfactant blend comprises combining a solvent, a surfactant, an alcohol and a salt that is selected from the group consisting of NaCl, KCl, CaCl₂ and MgCl₂ to form a solvent-surfactant blend.

35. The method of claim 20, wherein the steps of forming a solvent-surfactant blend and adding a diluent are carried out such that the emulsified solvent-surfactant blend comprises:
18% to 76% by volume surfactant;
7% to 54% by volume solvent;
up to 20% by volume alcohol; and
up to 50% by volume diluent.

36. The method of claim 35, wherein the step of combining the emulsified solvent-surfactant blend with an oil-based carrier fluid is carried out such that the well treatment microemulsion comprises:
from about 0.05% to about 50% by volume of emulsified solvent-surfactant blend; and
from about 50% to about 99.95% by volume of oil-based carrier fluid.

37. The method of claim 35, wherein the step of combining the solvent-surfactant blend with an oil-based carrier fluid is carried out such that the well treatment microemulsion comprises:
from about 0.2% to about 2% by volume of emulsified solvent-surfactant blend; and
from about 98% to about 99.8% by volume of oil-based carrier fluid.

38. A method of treating an oil or gas well with a well treatment microemulsion, wherein the oil or gas well has a well bore that contains a water-based fluid, the method comprising:
forming a solvent-surfactant blend by combing a solvent with a surfactant having a hydrophile-lipophile balance of about 8 to 20; and
forming the well treatment microemulsion by injecting the solvent-surfactant blend into the wellbore, wherein the solvent-surfactant blend mixes in situ with the water-based fluid.

39. A method of treating an oil or gas well with a well treatment microemulsion, wherein the oil or gas well has a well bore that contains an oil-based fluid, the method comprising:
forming a solvent-surfactant blend by combing a solvent with a surfactant having a hydrophile-lipophile balance of about 3 to 8; and
forming the well treatment microemulsion by injecting the solvent-surfactant blend through a capillary injection assembly into the wellbore, wherein the solvent-surfactant blend mixes in situ with the oil-based fluid.
